(19) United States
(12) Patent Application Publication
(10) Pub. No.: US 2025/0227466 A1
(43) Pub. Date: Jul. 10, 2025

(54) SECURITY KEY UPDATE IN WIRELESS NETWORKS

(71) Applicant: Samsung Electronics Co., Ltd., Suwon-si (KR)

(72) Inventors: Shiyang Leng, Allen, TX (US); Anil Agiwal, McKinney, TX (US); Kyeongin Jeong, Allen, TX (US)

(21) Appl. No.: 18/984,893

(22) Filed: Dec. 17, 2024

Related U.S. Application Data
(60) Provisional application No. 63/617,611, filed on Jan. 4, 2024.
(60) Provisional application No. 63/617,616, filed on Jan. 4, 2024.
(60) Provisional application No. 63/618,171, filed on Jan. 5, 2024.

(51) Int. Cl. H04W 12/0433; H04W 12/041; H04W 36/08

(52) U.S. Cl. CPC H04W 12/0433; H04W 12/041; H04W 36/08

(57) ABSTRACT

A user equipment (UE) receives master security key update information in the RRC (Radio Resource Control) reconfiguration message. UE receives a cell switch command for a master cell group (MCG) and performs the cell switch from a serving cell to a target cell. For the target cell, UE performs a security key update based on the master security key update information. UE receives a master security key update identifier for each candidate cell and maintains a variable to store a master security key update identifier for the serving cell. If the master security key update identifier of the target cell is different from that of the serving cell, UE performs a security key update for the cell switch.

### CROSS-REFERENCE TO RELATED APPLICATIONS

This application claims the benefit of priority from U.S. Provisional Application No. 63/617,611 entitled “MASTER SECURITY KEY UPDATE FOR L1/L2 TRIGGERED MOBILITY,” filed Jan. 4, 2024; U.S. Provisional Application No. 63/617,616 entitled “L2 SIGNALING FOR SECURITY KEY UPDATE FOR L1/L2 TRIGGERED MOBILITY,” filed Jan. 4, 2024; and U.S. Provisional Application No. 63/618,171 entitled “MASTER SECURITY KEY UPDATE FOR L1/L2 TRIGGERED MOBILITY,” filed Jan. 5, 2024, all which are incorporated herein by reference in their entirety.

### TECHNICAL FIELD

This disclosure relates generally to a wireless communication system, and more particularly to, for example, but not limited to, security key update in a wireless communication system.

### BACKGROUND

Mobility management operations including network handovers represent a pivotal aspect of any wireless communication system. These systems include, for example, LTE and 5G New Radio (NR), and upcoming technologies currently coined “6G”. Mobility is presently controlled by the network with user equipment (UE) assistance to maintain optimal connection quality. The network may hand over the UE to a target cell with superior signal quality.

The inclusion of enhanced broadband mechanisms requiring high speeds and low latencies has necessitated more sophisticated handover mechanisms. Accordingly, conditional handovers (CHOs) and separately, layer 1/layer 2 triggered mobility (LTM) have been introduced to provide additional conditions for specific networks or slices thereof to increase handover speed. The use of these enhancements, however, introduces latencies of its own, at least because the network needs to conduct several data exchanges with the UE during the handover process. The initiation of a prospective handover triggered by the network consequently introduces latencies, signaling overhead, and interruption times of its own.

The description set forth in the background section should not be assumed to be prior art merely because it is set forth in the background section. The background section may describe aspects or embodiments of the present disclosure.

### SUMMARY

An aspect of the disclosure provides a user equipment (UE) for facilitating communication in a wireless network. The UE comprises a transceiver configured to: receive, from a serving cell, master security key update information for one or more candidate cells; and receive, from the serving cell, a command indicating that a cell switch from the serving cell to a target cell among the one or more candidate cells is triggered. The UE comprises a processor operably coupled to the transceiver. The processor is configured to: perform the cell switch from the serving cell to the target cell; and perform a security update for the target cell based on master security key update information associated with the target cell.

In some embodiments, the transceiver is further configured to receive, from the serving cell, a master security key update identifier for each candidate cell. The processor is further configured to: maintain a variable to store a master security key update identifier for the serving cell; and perform the security update based on a determination that a master security key update identifier of the target cell is different from the master security key update identifier for the serving cell stored in the variable.

In some embodiments, the processor is further configured to replace the master security key update identifier stored in the variable with the master security key update identifier of the target cell.

In some embodiments, the transceiver is further configured to receive a list of master security update information including one or more entries for a respective candidate cell. Each entry comprises master security key update information.

In some embodiments, the processor is configured to perform the security update based on master security key update information in a predetermined entry or an entry indicated in the list of master security update information associated with the target cell.

In some embodiments, the processor is further configured to remove the predetermined entry or the entry indicated in the list of master security update information associated with the target cell.

In some embodiments, the command includes a master security update information identifier associated with the target cell, and the security update is performed based on master security update information identified by the master security update information identifier.

In some embodiments, the master security update information associated with the target cell is included in the command, and the security update for the target cell is performed based on the master security update information.

In some embodiments, the master security key update information includes a first field indicating whether the UE is required to derive a new master security key, and a second field including a parameter used to derive the new master security key.

An aspect of the disclosure provides a method performed by a user equipment (UE) in a wireless network. The method comprises: receiving, from a serving cell, master security key update information for one or more candidate cells; receiving, from the serving cell, a command indicating that a cell switch from the serving cell to a target cell among the one or more candidate cells is triggered; performing the cell switch from the serving cell to the target cell; and performing a security update for the target cell based on master security key update information associated with the target cell.

In some embodiments, the method further comprises: receiving, from the serving cell, a master security key update identifier for each candidate cell; maintaining a variable to store a master security key update identifier for the serving cell; and performing the security update based on a determination that a master security key update identifier of the target cell is different from the master security key update identifier for the serving cell stored in the variable.

In some embodiments, the method further comprises replacing the master security key update identifier stored in the variable with the master security key update identifier of the target cell.

In some embodiments, the method further comprises receiving a list of master security update information including one or more entries for a respective candidate cell. Each entry comprises master security key update information.

In some embodiments, the security update is performed based on master security key update information in a predetermined entry or an entry indicated in the list of master security update information associated with the target cell.

In some embodiments, the method further comprises removing the predetermined entry or the entry indicated in the list of master security update information associated with the target cell.

In some embodiments, the command includes a master security update information identifier associated with the target cell, and the security update is performed based on master security update information identified by the master security update information identifier.

In some embodiments, the master security update information associated with the target cell is included in the command, and the security update for the target cell is performed based on the master security update information.

In some embodiments, the master security key update information includes a first field indicating whether the UE is required to derive a new master security key, and a second field including a parameter used to derive the new master security key.

An aspect of the disclosure provides a base station (BS) for facilitating communication in a wireless network. The BS comprises a transceiver configured to: transmit, to a user equipment (UE), master security key update information for one or more candidate cells; and transmit, to the UE, a command indicating that a cell switch from a serving cell of the BS to a target cell among the one or more candidate cells is triggered. Master security key update information associated with the target cell is used for a security update for the target cell.

In some embodiments, the transceiver is further configured to transmit, to the UE, a master security key update identifier for each candidate cell.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example process for updating a master security key in accordance with an embodiment.

FIG. 5 shows an example process for updating a master security key in accordance with an embodiment.

FIG. 6 shows an example process for updating a master security key in accordance with an embodiment.

FIG. 7 shows an example process for updating a master security key in accordance with an embodiment.

FIG. 8 shows an example process for updating a master security key in accordance with an embodiment.

FIG. 9 shows an example process for updating a master security key in accordance with an embodiment.

FIG. 10 shows an example process for updating a master security key in accordance with an embodiment.

FIG. 11 shows an example process for updating a master security key update in accordance with an embodiment.

FIG. 12 shows an example of an LTM cell switch command MAC CE in accordance with an embodiment.

FIG. 13 shows an example MAC subheader for the LTM cell switch MAC CE in accordance with an embodiment.

FIG. 14 shows an example of an LTM cell switch command MAC CE in accordance with an embodiment.

FIG. 15 shows an example of an LTM cell switch command MAC CE in accordance with an embodiment.

FIG. 16 shows an example of an LTM cell switch command MAC CE in accordance with an embodiment.

FIG. 17 shows an example of an LTM cell switch command MAC CE in accordance with an embodiment.

FIG. 18 shows an example process for updating a master security key update in accordance with an embodiment

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

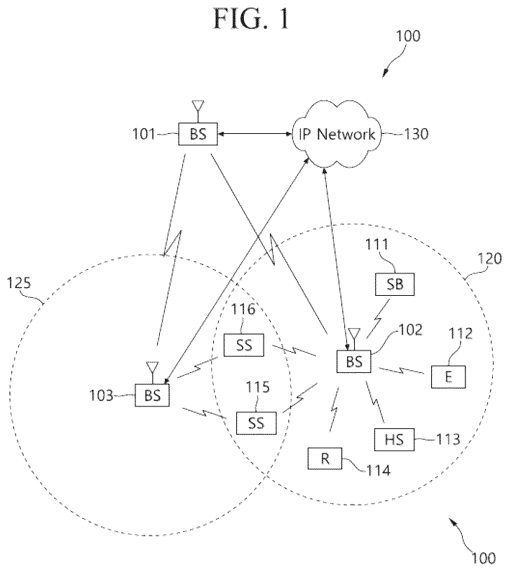

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (TP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with APs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

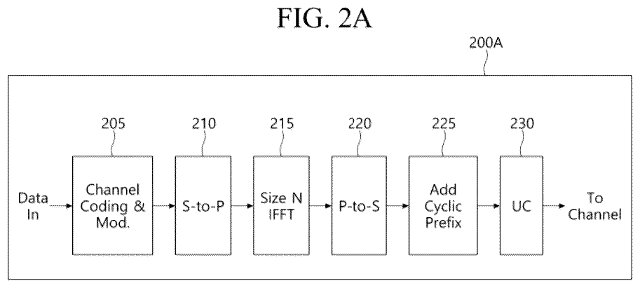

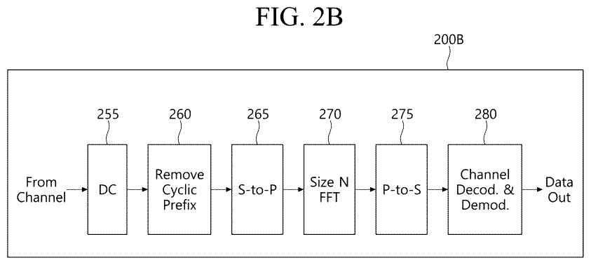

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

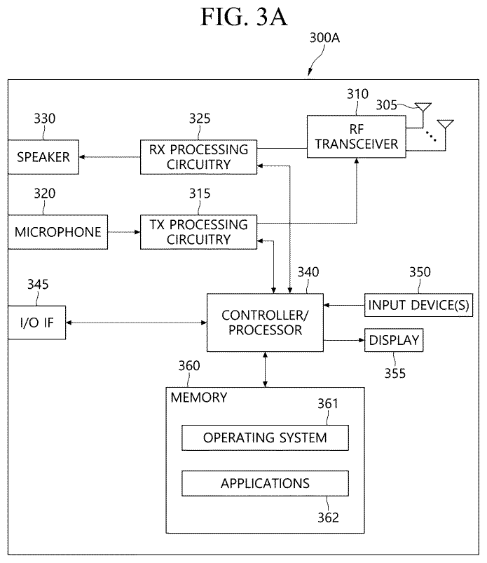

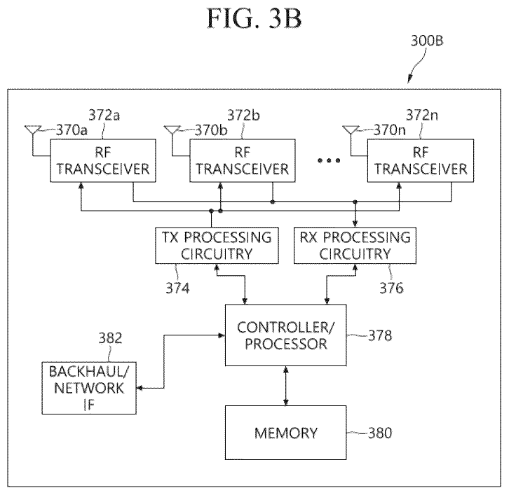

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release13 of the LTE standard supports up to 16 CSI-RS [channel status information—reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel.14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power) and reports the results to the BS.

The BS 300B of FIG. 3B may also include additional or different types of memory 380, including dynamic random-access memory (DRAM), non-volatile flash memory, static RAM (SRAM), different levels of cache memory. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM) may be formulated by the inventors and designed to assist in providing an efficient description of the unique features within the disclosure. A list of both common and unique acronyms follows.

### Abbreviations:

L1 Layer 1
L2 Layer 2
L3 Layer 3
UE User Equipment
gNB Base Station
NW Network
NR New Radio
3GPP 3rd Generation Partnership Project
HO Handover
CHO Conditional Handover
MCG Master Cell Group
SCG Secondary Cell Group
AS Access Stratum
NAS Non-access Stratum
RRC Radio Resource Control
DU Distributed Unit
CU Central Unit
UL-SCH Uplink Shared Channel
DL-SCH Downlink Shared Channel
DL Downlink
UL Uplink
IE Information Element
SpCell Special Cell
SCell Secondary Cell
PSCell Primary Secondary Cell

The following documents are hereby incorporated by reference in their entirety into the present disclosure as if fully set forth herein: i) 3GPP TS 38.300 v17.6.0; ii) 3GPP TS 38.331 v17.6.0; and iii) 3GPP TS 38.321 v17.6.0.

3GPP (Third-Generation Partnership Project) has developed technical specifications and standards to define the new 5G radio-access technology, known as 5G NR. Mobility handling is a critical aspect in any mobile communication system including 5G system. For the mobility in a connected mode, the handover is initiated by the network through higher layer signaling, such as an RRC message, based on Layer 3 (L3) measurement. However, this procedure introduces increased latency, signaling overhead, and interruption time, which may become critical in some scenarios with frequent handover, such as when a UE moves at high speed in vehicular environments or in frequency range 2 (FR2) deployment. It is necessary to reduce latency, signaling overhead, and interruption time during handover. This necessitates the adoption of L1/L2 Triggered Mobility (LTM), where the handover is triggered by L1/L2 signaling based on L1 measurement. More specifically, LTM refers to a mobility mechanism in which UE switches from the source cell to a target cell using beam switching triggered by L1/L2 signaling, with the beam switching decision based on L1 measurements of beams among neighboring cells.

In Release-18, a subsequent LTM has been introduced for intra-gNB-CU scenarios. In the subsequent LTM, cell switch between cells within the same gNB or CU is supported. The cell switch between L1/L2 mobility candidates is performed without requiring RRC reconfiguration, and the security key remains unchanged (i.e., not updated) during the intra-gNB-CU LTM cell switch. For an LTM candidate cell, the master key update, which is used to configure the security key update, is absent in the LTM candidate cell configuration for Release-18 LTM. Therefore, UE retains the current security key as used for the source cell without updating it for the target cell.

In Release-19 or the next generation of wireless communications, LTM may be extended to inter-gNB-CU scenarios to support cell switch between cells of different BSs (e.g., gNB or CU). In these scenarios, RRC reconfiguration during LTM cell switches may be avoided by pre-configuring a list of LTM candidate cells.

For inter-gNB-CU LTM in Master Cell Group (MCG), a master security key has to be updated when the source cell and the target cell belong to different gNB or CU. Therefore, for inter-gNB-CU LTM in the MCG, UE has to perform master security key update. However, in subsequent LTM or conditional LTM, both inter-CU LTM and intra-CU LTM may occur, and the network may not know in advance whether the next cell switch will be inter-CU LTM or intra-CU LTM. Therefore, the configuration of master security key updates for a list of LTM candidate cells, as well as the security key update procedure for an LTM cell switch, need to be specified to support both intra-CU LTM and inter-CU LTM in MCG. Additionally, a configuration of signaling the security key update information, for example by L2 signaling for the LTM cell switch execution, needs to be specified to support both intra-CU LTM and inter-CU LTM in MCG.

The present disclosure provides master security key update configurations and master security key update procedures for both intra-CU LTM and inter-CU LTM. The present disclosure provides a signaling procedure for security key update for both intra-CU LTM and inter-CU LTM.

Various embodiments introduced in the disclosure may be applicable to subsequent LTM and conditional LTM for intra-CU mobility and inter CU mobility.

In some embodiments, for each LTM candidate cell, the network configures master security key update in IE ltm-CandidateConfig, which includes the RRCReconfiguration message used to configure the LTM candidate cell. For example, the IE ltm-CandidateConfig includes the IE masterKeyUpdate within the RRCReconfiguration message. In an embodiment, the IE masterKeyUpdate is present within the RRCReconfiguration message container in the ltm-CandidateConfig for each LTM candidate cell when synchronous reconfiguration (ReconfigurationWithSync IE) is part of an LTM-Candidate IE associated with the MCG.

In some embodiments, the IE masterKeyUpdate may include a field keySetChangeIndicator, which indicates whether UE needs to derive a new master key (K_gNB). When reconfigurationWithSync is included, a value of “true” may indicate that the K_gNB is derived from a security key (K_AMF) used in the latest successful non-access stratum (NAS) security mode command (SMC) procedure, or N2 handover procedure with K_AMF change. A value of “false” may indicate that the K_gNB is obtained from the current K_gNB or from the next hop (NH). This field may be mandatory present in IE masterKeyUpdate for an LTM candidate cell.

In some embodiments, the IE masterKeyUpdate may include a field nextHopChainingCount, which indicates a parameter used to derive the K_gNB key if keySetChangeIndicator is set to a value of “false.” This field may be mandatory present in IE masterKeyUpdate for an LTM candidate cell.

In some embodiments, the IE masterKeyUpdate can include a field nas-Container. This field is used to transfer UE specific NAS layer information between the network and the UE. The RRC layer is transparent for this field, although it affects activation of access stratum (AS) security after inter-system handover to NR system. This field may be optionally present in IE masterKeyUpdate for an LTM candidate cell.

In some embodiments, for each LTM candidate cell associated with MCG, UE receives master security key update information (e.g., IE masterKeyUpdate) within the RRC reconfiguration message in IE ltm-CandidateConfig. For LTM cell switch execution, when the LTM cell switch is triggered by an indication from a lower layer (L1 or L2) or conditional reconfiguration execution is performed for a subsequent LTM, UE may apply the RRC reconfiguration message in ltm-CandidateConfig within LTM-Candidate IE in VarLTM-Config identified by the LTM candidate configuration identity received from the lower layer. If the IE masterKeyUpdate is included in the RRC reconfiguration message, UE performs an access stratum (AS) security key update procedure.

Additionally, if the LTM cell switch is triggered upon cell selection performed while timer T311 was running, UE may apply the RRC reconfiguration message in ltm-CandidateConfig within LTM-Candidate IE in VarLTM-Config associated with the LTM candidate configuration identity for the selected cell. If the masterKeyUpdate is included in the RRC reconfiguration message, UE performs an AS security key update procedure.

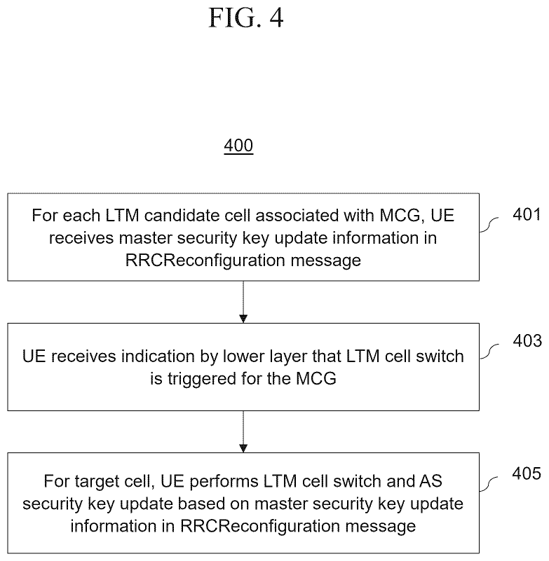

FIG. 4 shows an example process 400 for updating a master security key in accordance with an embodiment. For explanatory and illustration purposes, the example process 400 may be performed by a UE. Although one or more operations are described or shown in particular sequential order, in other embodiments the operations may be rearranged in a different order, which may include performance of multiple operations in at least partially overlapping time periods. In this example, the master security key update in LTM uses information in RRC reconfiguration container.

Referring to FIG. 4, the process 400 may begin in operation 401. In operation 401, for each LTM candidate cell associated with MCG, UE receives master security key update information in RRCReconfiguration message. In an implementation, UE receives master security key update information (e.g., IE masterKeyUpdate) within RRCReconfiguration message container in the ltm-CandidateConfig. Then, the process 400 proceeds to operation 403.

In operation 403, UE receives an indication by a lower layer (L1 or L2) that an LTM cell switch from a source cell to a target cell is triggered for the MCG. Then, the process 400 proceeds to operation 405.

In operation 405, for the target cell, UE performs the LTM cell switch and an AS security key update based on the master security key update information (e.g., IE masterKeyUpdate) in the RRCReconfiguration message.

In some embodiments, a master security key update ID and associated master security key update information may be configured for each candidate cell. Additionally, a master security key update ID for a serving cell may be configured for the serving cell. For LTM candidate cells belonging to the same BS, gNB, or CU (i.e., intra-CU candidate cells) as the serving cell, the network may configure the master security key update ID for the candidate cell to be the same as that of the serving cell. Conversely, for LTM candidate cells belonging to different BSs, gNBs or CUs from the serving cell, the network may configure the master security key update ID for the candidate cell to differ from the master security key update ID of the serving cell. UE may determine whether to perform the master security key update for an LTM cell switch by comparing the master security key update ID of the serving cell with that of the candidate cell.

In some embodiments, for each LTM candidate cell associated with the MCG, UE receives a master security key update ID for a serving cell, a master security key update ID of each candidate cell, and master security key update information (e.g., IE masterKeyUpdate) for each candidate cell in the LTM configuration. In an implementation, for each LTM candidate cell associated with the MCG, master security key update information (e.g., IE masterKeyUpdate) may be included within the RRCReconfiguration message in IE ltm-CandidateConfig in ltm-Candidate of the LTM configuration. The IE masterKeyUpdate may be present in the RRCReconfiguration message in the ltm-CandidateConfig for each LTM candidate cell when ReconfigurationWithSync is part of an LTM-Candidate IE associated with the MCG. The master security key update information (e.g., IE masterKeyUpdate) may include elements as described above.

In some embodiments, a master security key update ID (e.g., ltm-MasterKeyUpdateID) is included in ltm-Candidate for each LTM candidate cell in the LTM configuration, and a serving cell master security key update ID (e.g., ltm-ServingCellMasterKeyUpdateID) is included in the LTM configuration. UE maintains a variable (VarLTM-ServingCellMasterKeyUpdateID) to store the serving cell master security key update ID associated with the LTM configuration for the MCG and performs the following operations:
if the received LTM-Config includes ltm-ServingCellMasterKeyUpdateID:
   if the current VarLTM-ServingCellMasterKeyUpdateID includes an ltm-ServingCellMasterKeyUpdateID:
      replace the ltm-ServingCellMasterKeyUpdateID value within VarLTM-ServingCellMasterKeyUpdateID with the received ltm-ServingCellMasterKeyUpdateID;
   else:
      store the received ltm-ServingCellMasterKeyUpdateID in VarLTM-ServingCellMasterKeyUpdateID.

In some embodiments, for the cell group for which the LTM configuration release is triggered, when UE performs RRC re-establishment or RRC release, or when UE transitions to RRC idle, the UE may remove all entries in the VarLTM-ServingCellMasterKeyUpdateID.

In some embodiments, for LTM cell switch execution, upon receiving an indication from a lower layer (L1 or L2) that an LTM cell switch is triggered for the MCG, or upon performing LTM cell switch following cell selection performed while timer T311 is running, UE may retain the variable VarLTM-ServingCellMasterKeyUpdateID. In an implementation, UE may perform the following operations:
If the LTM cell switch is triggered by an indication from a lower layer or (conditional) reconfiguration execution is performed for subsequent LTM, UE applies the RRCReconfiguration message in ltm-CandidateConfig within IE tm-Candidate IE in VarLTM-Config identified by the LTM candidate configuration identity received from a lower layer;
   If the masterKeyUpdate is included in the RRCReconfiguration message:
      if the value of field ltm-MasterKeyUpdateID included within the LTM-Candidate IE in VarLTM-Config for the target cell indicated by lower layers or for the selected cell in cell reselection is not equal to the value of ltm-ServingCellMasterKeyUpdateID within VarLTM-ServingCellMasterKeyUpdateID:
         perform AS security key update procedure;
         replace the value of ltm-ServingCellMasterKeyUpdateID in VarLTM-ServingCellMasterKeyUpdateID with the value of ltm-MasterKeyUpdateID in the LTM-Candidate in VarLTM-Config;
else, for example, LTM cell switch triggered upon cell selection performed while timer T311 is running, UE applies the RRCReconfiguration message in ltm-CandidateConfig within ltm-Candidate IE in VarLTM-Config related to the LTM candidate configuration identity for the selected cell.
   If the masterKeyUpdate is included in the RRCReconfiguration message:
      if the value of field ltm-MasterKeyUpdateID contained within the LTM-Candidate IE in VarLTM-Config for the target cell indicated by lower layers or for the selected cell in cell reselection is not equal to the value of ltm-ServingCellMasterKeyUpdateID within VarLTM-ServingCellMasterKeyUpdateID:
         perform AS security key update procedure;
         replace the value of ltm-ServingCellMasterKeyUpdateID in VarLTM-ServingCellMasterKeyUpdateID with the value of ltm-MasterKeyUpdateID in the LTM-Candidate in VarLTM-Config.

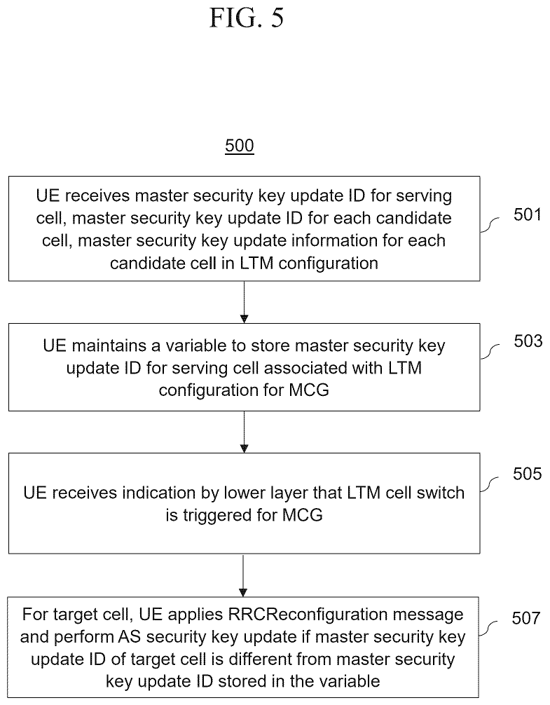

FIG. 5 shows an example process 500 for updating a master security key in accordance with an embodiment. For explanatory and illustration purposes, the example process 500 may be performed by a UE. Although one or more operations are described or shown in particular sequential order, in other embodiments the operations may be rearranged in a different order, which may include performance of multiple operations in at least partially overlapping time periods.

Referring to FIG. 5, the process 500 may begin in operation 501. In operation 501, UE receives a master security key update ID for a serving cell, a master security key update ID for each candidate cell, and master security key update information (e.g., IE masterKeyUpdate) for each candidate cell in the LTM configuration. Then, the process 500 proceeds to operation 503.

In operation 503, UE maintains a variable to store the master security key update ID for the serving cell associated with the LTM configuration for the MCG. Then, the process 500 proceeds to operation 505.

In operation 505, UE receives an indication by a lower layer (L1 or L2) that an LTM cell switch from a source cell to a target cell is triggered by for the MCG. Then, the process 500 proceeds to operation 507.

In operation 507, for the target cell, UE performs the LTM cell switch. UE may apply the RRCReconfiguration message in the ltm-CandidateConfig and perform an AS security key update if the master security key update ID of the target cell is different from the master security key update ID of the serving cell which is stored in the variable.

In some embodiments, a security configuration may be configured for LTM, a master security key update ID may be configured for each candidate cell, and a serving cell master security key update ID may be configured for the serving cell. For LTM candidate cells belonging to the same BS, gNB, or CU (i.e., intra-CU candidate cells) as the serving cell, the network may configure the master security key update ID for the candidate cell to be the same as that of the serving cell. Conversely, for LTM candidate cells belonging to different BSs, gNBs or CUs from the serving cell, the network may configure a master security key update ID for the candidate cell different from that of the serving cell. UE may determine whether to perform master security key update for an LTM by comparing the master security key update ID of the serving cell with that of the LTM candidate cell.

In some embodiments, UE receives the MCG LTM configuration which includes a security configuration, a serving cell master security key update ID, and a master security key update ID for each LTM candidate cell. In an implementation, a security configuration (ltm-SecurityConfig) is included in the LTM configuration for the MCG (LTM-Config). The ltm-SecurityConfig includes a list of master security configurations to add or to modify (ltm-masterSecurityCellSetToAddModList), and a list of master security configurations to release (ltm-masterSecurityCellSetToReleaseList), as shown below:
The ltm-masterSecurityCellSetToAddModList includes a list of master security configurations (ltm-masterSecurityConfig), where each ltm-masterSecurityConfig can include
   a list of the LTM master security key update information (ltm-masterKeyUpdateList), and each entry (ltm-masterKeyUpdate) in the list can include
      the ID of the LTM master security key update information (ltm-masterKeyID), and/or
      a field keySetChangeIndicator and/or
      a field nextHopChainingCount and/or
      a field nas-Container.
   the master security key update ID (ltm-masterKeyUpdateID).
The ltm-masterSecurityCellSetToReleaseList can include a list of master security key update IDs, (ltm-masterKeyUpdateID).

In some embodiments, UE maintains a variable (VarLTM-Config) to store the security configuration for the LTM configuration of MCG and performs the following operations:
if the received LTM-Config includes ltm-masterSecurityCellSetToReleaseList:
   if VarLTM-Config includes an ltm-masterSecurityConfig associated with an ltm-masterKeyUpdateID that is included in ltm-masterSecurityCellSetToReleaseList,
      remove the entry ltm-masterSecurityConfig associated with the ltm-masterKeyUpdateID from VarLTM-Config.
if the received LTM-Config includes ltm-masterSecurityCellSetToAddModList:
   For an ltm-masterSecurityConfig with an ltm-masterKeyUpdateID in ltm-masterSecurityCellSetToAddModList, and if VarLTM-Config includes an ltm-masterSecurityConfig with the same ltm-masterKeyUpdateID,
      replace the entry ltm-masterSecurityConfig in VarLTM-Config with the received ltm-masterSecurityConfig identified by the ltm-masterKeyUpdateID;
   else,
      add the received ltm-masterSecurityConfig with the ltm-masterKeyUpdateID to VarLTM-Config.

In some embodiments, a master security key update ID (ltm-MasterKeyUpdateID) is included in IE ltm-Candidate for each LTM candidate cell in the LTM configuration, and a serving cell master security key update ID (ltm-ServingCellMasterKeyUpdateID) is included in the LTM configuration (LTM-Config). UE maintains a variable (VarLTM-ServingCellMasterKeyUpdateID) to store the serving cell master security key update ID associated with the LTM configuration for the MCG and performs the following operations:
if the received LTM-Config includes ltm-ServingCellMasterKeyUpdateID:
   if the current VarLTM-ServingCellMasterKeyUpdateID includes an ltm-ServingCellMasterKeyUpdateID:
      replace the ltm-ServingCellMasterKeyUpdateID value within VarLTM-ServingCellMasterKeyUpdateID with the received ltm-ServingCellMasterKeyUpdateID;
   else:
      store the received ltm-ServingCellMasterKeyUpdateID in VarLTM-ServingCellMasterKeyUpdateID.

In some embodiments, for the cell group for which the LTM configuration release is triggered, when UE performs RRC re-establishment or RRC release, or when UE transitions to RRC idle, UE may remove all entries within VarLTM-ServingCellMasterKeyUpdateID.

In some embodiments, for LTM cell switch execution, upon receiving an indication from a lower layer (L1 or L2) that an LTM cell switch is triggered for the MCG, or upon performing LTM cell switch following cell selection performed while timer T311 is running, UE may retain or maintain the variable VarLTM-ServingCellMasterKeyUpdateID, and may perform the following operations:
If the LTM cell switch is triggered by an indication from lower layers or LTM cell switch triggered upon cell selection performed while timer T311 is running, or (conditional) reconfiguration execution is performed for subsequent LTM:
   UE applies the RRCReconfiguration message in ltm-CandidateConfig within LTM-Candidate IE in VarLTM-Config identified by the LTM candidate configuration identity received from lower layers, and/or
   if the value of field ltm-MasterKeyUpdateID contained within the LTM-Candidate IE in VarLTM-Config for the target cell indicated by lower layers or for the selected cell in cell reselection is not equal to the value of ltm-ServingCellMasterKeyUpdateID within VarLTM-ServingCellMasterKeyUpdateID:
      in ltm-masterSecurityConfig in VarLTM-Config with the ltm-MasterKeyUpdateID same as the ltm-MasterKeyUpdateID contained within the LTM-Candidate for the target cell, consider ltm-masterKeyUpdate in the first entry of the ltm-masterKeyUpdateList,
      perform AS security key update procedure using the information in ltm-masterKeyUpdate, and/or
      remove the selected ltm-masterKeyUpdate in the ltm-masterKeyUpdateList included in ltm-masterSecurityConfig in VarLTM-Config,
      replace the value of ltm-ServingCellMasterKeyUpdateID in VarLTM-ServingCellMasterKeyUpdateID with the value of ltm-MasterKeyUpdateID in the LTM-Candidate for the target cell.

In some embodiments, the LTM cell switch command MAC CE may include a field indicating the Master Key ID to identify the master security key update information configured in higher layer. UE may apply the ltm-masterKeyUpdate identified by the ltm-masterKeyID that has the same value of Master Key ID indicated in the MAC CE for master security key update. For LTM cell switch execution, upon receiving an indication by lower layers that an LTM cell switch is triggered for the MCG, the UE performs the following operations:
If the LTM cell switch is triggered by an indication from lower layers, or if (conditional) reconfiguration execution is performed for subsequent LTM:
   UE applies the RRCReconfiguration message in ltm-CandidateConfig within LTM-Candidate IE in VarLTM-Config identified by the LTM candidate configuration identity received from lower layers, and/or
   if the value of field ltm-MasterKeyUpdateID contained within the LTM-Candidate IE in VarLTM-Config for the target cell indicated by lower layers or for the selected cell in cell reselection is not equal to the value of ltm-ServingCellMasterKeyUpdateID within VarLTM-ServingCellMasterKeyUpdateID, and if the value of Master Key ID is received from the lower layer:
      in ltm-masterSecurityConfig in VarLTM-Config with the ltm-MasterKeyUpdateID same as the ltm-MasterKeyUpdateID contained within the LTM-Candidate for the target cell, consider the ltm-masterKeyUpdate in the ltm-masterKeyUpdateList that is identified by an ltm-masterKeyID matching the value of Master Key ID indicated by lower layers,
      perform AS security key update procedure using the information in ltm-masterKeyUpdate, and/or
      remove the selected ltm-masterKeyUpdate in the ltm-masterKeyUpdateList included in ltm-masterSecurityConfig in VarLTM-Config,
      replace the value of ltm-ServingCellMasterKeyUpdateID in VarLTM-ServingCellMasterKeyUpdateID with the value of ltm-MasterKeyUpdateID in the LTM-Candidate in VarLTM-Config.

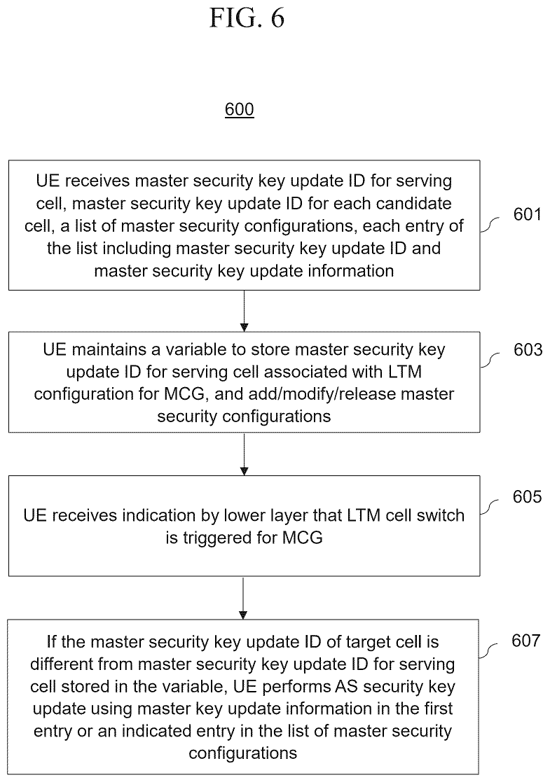

FIG. 6 shows an example process 600 for updating a master security key in accordance with an embodiment. For explanatory and illustration purposes, the example process 600 may be performed by a UE. Although one or more operations are described or shown in particular sequential order, in other embodiments the operations may be rearranged in a different order, which may include performance of multiple operations in at least partially overlapping time periods.

Referring to FIG. 6, the process 600 may begin in operation 601. In operation 601, UE receives a master security key update ID for a serving cell, a master security key update ID for each candidate cell, and a list of master security configurations in an LTM configuration. Each entry of the list of master security configurations includes a master security key update ID and master key update information including a master security key update list. Then, the process 600 proceeds to operation 603.

In operation 603, UE may maintain a variable to store the master security key update ID for the serving cell associated with the LTM configuration for the MCG. Additionally, UE may add, modify, or release master security configurations based on the LTM configuration. Then, the process 600 proceeds to operation 605.

In operation 605, UE may receive an indication by a lower layer (L1 or L2) that an LTM cell switch from a source cell to a target cell is triggered by for the MCG. Then, the process 600 proceeds to operation 607.

In operation 607, UE performs the LTM cell switch. UE may determine whether the master security key update ID of the target cell is different from the master security key update ID for the serving cell stored in the variable. If the master security key update ID of the target cell is different from the master security key update ID, UE may perform an AS security key update based on the master key update information included in the first entry of the list of master security configurations. In another embodiment, UE may perform the AS security key update based on the master key update information included in an entry of the list of master security configurations, which is indicated by the master security key update ID of the target cell.

In some embodiments, a security configuration, including a list of master security key update information, is configured for LTM, while a master security key update ID for each candidate cell and a master security key update ID for a serving cell are configured. For LTM candidate cells belonging to the same BS, gNB, or CU (i.e., intra-CU candidate cells) as the serving cell, the network can configure the master security key update ID for the candidate cell to be the same as that of the serving cell. For LTM candidate cells belonging to different BSs, gNBs or CUs from the serving cell, the network can configure a master security key update ID for the candidate cell different from that of the serving cell. UE determines whether to perform master security key update procedure for an LTM by comparing the master security key update ID of the serving cell with that of the LTM candidate cell.

In some embodiments, UE receives an MCG LTM configuration which includes a security configuration, a serving cell master security key update ID, and a master security key update ID for each LTM candidate cell. In an implementation, a security configuration (ltm-SecurityConfig) is included in the LTM configuration for the MCG (LTM-Config). The ltm-SecurityConfig includes a list of master security configurations to add or to modify (ltm-masterSecurityConfigToAddModList), and a list of master security configurations to release (ltm-masterSecurityConfigToReleaseList). UE may perform the following operations:
The ltm-masterSecurityConfigToAddModList can include
   a list of the LTM master security key update configuration (ltm-masterSecurityConfig), and each entry includes
      the ID of the LTM master security information (ltm-masterSecurityConfigID), and/or
      a field keySetChangeIndicator as aforementioned, and/or
      a field nextHopChainingCount as aforementioned, and/or
      a field nas-Container as aforementioned.
The ltm-masterSecurityCellSetToReleaseList can include the IDs of master security key update configuration (ltm-masterSecurityConfigID).

In some embodiments, when the security configuration (ltm-SecurityConfig) is included in the LTM configuration, UE maintains a variable (VarLTM-Config) to store the security configuration for the LTM configuration of MCG and performs the following operations:
if the received LTM-Config includes ltm-masterSecurityConfigToReleaseList:
   if VarLTM-Config includes an ltm-masterSecurityConfig with an ltm-masterSecurityConfigID that is included in ltm-masterSecurityConfigToReleaseList,
      remove the entry ltm-masterSecurityConfig identified by the ltm-masterSecurityConfigID from VarLTM-Config.
if the received LTM-Config includes ltm-masterSecurityConfigToAddModList:
For an ltm-masterSecurityConfig with an ltm-masterSecurityConfigID in ltm-masterSecurityConfigToAddModList, and if VarLTM-Config includes an ltm-masterSecurityConfig with the same ltm-masterSecurityConfigID,
   replace the entry ltm-masterSecurityConfig in VarLTM-Config with the received ltm-masterSecurityConfig identified by the ltm-masterSecurityConfigID;
else,
   add the received ltm-masterSecurityConfig with the ltm-masterSecurityConfigID to VarLTM-Config.

In some embodiments, a master security key update ID (ltm-MasterKeyUpdateID) is included in IE ltm-Candidate for each LTM candidate cell in the LTM configuration, and a serving cell master security key update ID (ltm-ServingCellMasterKeyUpdateID) is included in the LTM configuration (LTM-Config). When the serving cell master security key update ID is configured, UE can maintain a variable (VarLTM-ServingCellMasterKeyUpdateID) to store the serving cell master security key update ID associated with the LTM configuration for the MCG and performs the following operations:
if the received LTM-Config includes ltm-ServingCellMasterKeyUpdateID:
   if the current VarLTM-ServingCellMasterKeyUpdateID includes an ltm-ServingCellMasterKeyUpdateID:
      replace the ltm-ServingCellMasterKeyUpdateID value within VarLTM-ServingCellMasterKeyUpdateID with the received ltm-ServingCellMasterKeyUpdateID;
   else:
      store the received ltm-ServingCellMasterKeyUpdateID in VarLTM-ServingCellMasterKeyUpdateID.

In some embodiments, for the cell group for which the LTM configuration release is triggered, when UE performs RRC re-establishment or RRC release, or when UE goes to RRC idle, UE may remove all entries within VarLTM-ServingCellMasterKeyUpdateID.

In some embodiments, the LTM cell switch command MAC CE can include a field indicating a Master Key ID to identify the master security key update information configured in a higher layer. UE applies the ltm-masterSecurityConfig identified by the master security configuration ID (ltm-masterSecurityConfigID) that has the same value of Master Key ID indicated in the MAC CE for master security key update. For LTM cell switch execution, upon receiving an indication by a lower layer that an LTM cell switch is triggered for the MCG, UE performs the following operations:
If the LTM cell switch is triggered by an indication from lower layers, or if (conditional) reconfiguration execution is performed for subsequent LTM:
   UE applies the RRCReconfiguration message in ltm-CandidateConfig within LTM-Candidate IE in VarLTM-Config identified by the LTM candidate configuration identity received from lower layers, and/or
   if the value of field ltm-MasterKeyUpdateID contained within the LTM-Candidate IE in VarLTM-Config for the target cell indicated by lower layers or for the selected cell in cell reselection is not equal to the value of ltm-ServingCellMasterKeyUpdateID within VarLTM-ServingCellMasterKeyUpdateID, and if the value of Master Key ID is received from the lower layer:
      consider the ltm-masterSecurityConfig in the VarLTM-Config identified by ltm-masterSecurityConfigID that has the value of Master Key ID indicated by lower layers,
      perform AS security key update procedure using the information in ltm-masterSecurityConfig, and/or
      remove the selected ltm-masterSecurityConfig in VarLTM-Config,
      replace the value of ltm-ServingCellMasterKeyUpdateID in VarLTM-ServingCellMasterKeyUpdateID with the value of ltm-MasterKeyUpdateID in the LTM-Candidate in VarLTM-Config.

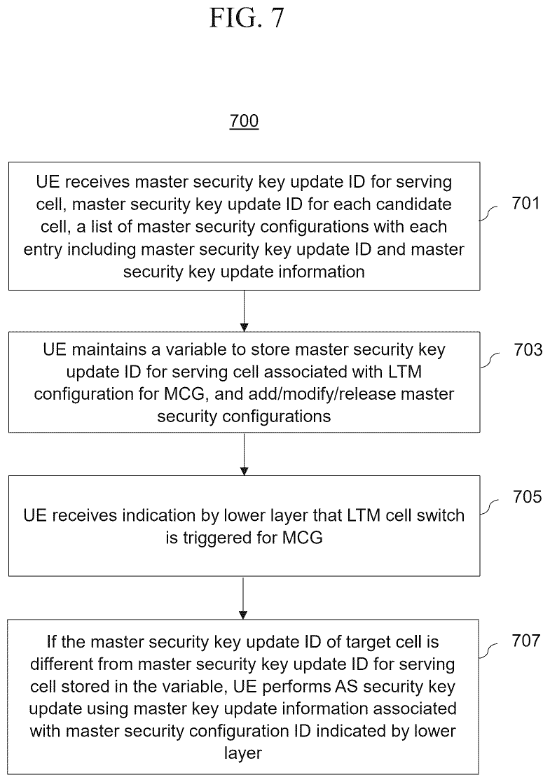

FIG. 7 shows an example process 700 for updating a master security key in accordance with an embodiment. For explanatory and illustration purposes, the example process 700 may be performed by a UE. Although one or more operations are described or shown in particular sequential order, in other embodiments the operations may be rearranged in a different order, which may include performance of multiple operations in at least partially overlapping time periods. In this example, the master security key update in LTM is based on a master security key update ID and pre-configured master security key update information.

Referring to FIG. 7, the process 700 may begin in operation 701. In operation 701, UE receives a master security key update ID for a serving cell, a master security key update ID for each candidate cell, and a list of master security configurations in an LTM configuration. Each entry of the list of master security configurations includes a master security key update ID and master security key update information. Then, the process 700 proceeds to operation 703.

In operation 703, UE may maintain a variable to store the master security key update ID for the serving cell associated with the LTM configuration for the MCG. Additionally, UE may add, modify, or release one or more master security configurations based on the LTM configuration. Then, the process 700 proceeds to operation 705.

In operation 705, UE may receive an indication by a lower layer (L1 or L2) that an LTM cell switch from a source cell to a target cell is triggered by for the MCG. Then, the process 700 proceeds to operation 707.

In operation 707, UE performs the LTM cell switch. UE may determine whether the master security key update ID of the target cell is different from the master security key update ID for the serving cell stored in the variable. If the master security key update ID of the target cell is different from the master security key update ID of the serving cell, UE may perform an AS security key update based on the master key update information associated with master security configuration ID indicated by the lower layer.

In some embodiments, a security configuration including a list of master security key update information can be configured for LTM. The network indicates an ID of the master security key update information so that UE can perform master security key update.

In some embodiments, UE receives an MCG LTM configuration which includes a security configuration. The security configuration (ltm-SecurityConfig) may be included in the LTM configuration for the MCG (LTM-Config). The ltm-SecurityConfig may include a list of master security configurations to add or to modify (ltm-masterSecurityConfigToAddModList), and a list of master security configurations to release (ltm-masterSecurityConfigToReleaseList). Below is an example:
The ltm-masterSecurityConfigToAddModList can include
   a list of the LTM master security key update configuration (ltm-masterSecurityConfig), and each entry includes
      the ID of the LTM master security information (ltm-masterSecurityConfigID), and/or
      a field keySetChangeIndicator as aforementioned, and/or
      a field nextHopChainingCount as aforementioned, and/or
      a field nas-Container as aforementioned.
The ltm-masterSecurityCellSetToReleaseList can include the IDs of master security key update configuration, (e.g., ltm-masterSecurityConfigID).

In some embodiments, the security configuration (ltm-SecurityConfig) may be included in the LTM configuration. UE may retain or maintain a variable (VarLTM-Config) to store the security configuration for the LTM configuration of MCG and performs the following operations:
if the received LTM-Config includes ltm-masterSecurityConfigToReleaseList:
   if VarLTM-Config includes an ltm-masterSecurityConfig with an ltm-masterSecurityConfigID that is included in ltm-masterSecurityConfigToReleaseList,
      remove the entry ltm-masterSecurityConfig identified by the ltm-masterSecurityConfigID from VarLTM-Config.
if the received LTM-Config includes ltm-masterSecurityConfigToAddModList:
   For an ltm-masterSecurityConfig with an ltm-masterSecurityConfigID in ltm-masterSecurityConfigToAddModList, and if VarLTM-Config includes an ltm-masterSecurityConfig with the same ltm-masterSecurityConfigID,
      replace the entry ltm-masterSecurityConfig in VarLTM-Config with the received ltm-masterSecurityConfig identified by the ltm-masterSecurityConfigID;
   else,
      add the received ltm-masterSecurityConfig with the ltm-masterSecurityConfigID to VarLTM-Config.

In some embodiments, an LTM cell switch command MAC CE may include a field to indicate a Master Key ID to identify the master security key update information configured in a higher layer. UE applies the ltm-masterSecurityConfig identified by the ltm-masterSecurityConfigID that has the same value of Master Key ID indicated in the MAC CE for master security key update. For LTM cell switch execution, upon receiving an indication by lower layers that an LTM cell switch is triggered for the MCG, the UE performs the following operations:
If the LTM cell switch is triggered by an indication from lower layers, or if (conditional) reconfiguration execution is performed for subsequent LTM:
   UE applies the RRCReconfiguration message in ltm-CandidateConfig within LTM-Candidate IE in VarLTM-Config identified by the LTM candidate configuration identity received from lower layers, and/or
   if the value of Master Key ID is received from the lower layer:
      consider the ltm-masterSecurityConfig in the VarLTM-Config identified by ltm-masterSecurityConfigID that has the value of Master Key ID indicated by lower layers,
      perform AS security key update procedure using the information in ltm-masterSecurityConfig, and/or
      remove the selected ltm-masterSecurityConfig in VarLTM-Config.

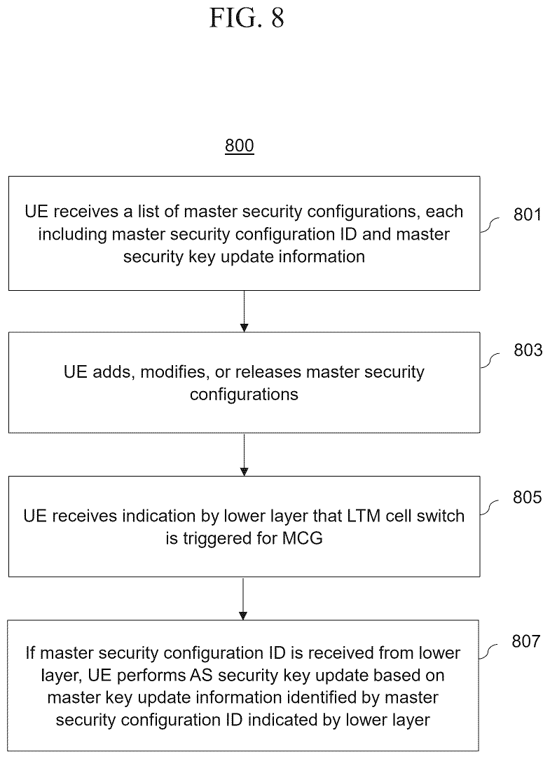

FIG. 8 shows an example process 800 for updating a master security key in accordance with an embodiment. For explanatory and illustration purposes, the example process 800 may be performed by a UE. Although one or more operations are described or shown in particular sequential order, in other embodiments the operations may be rearranged in a different order, which may include performance of multiple operations in at least partially overlapping time periods. In this example, the master security key update in LTM is based on pre-configured master security key update information and an indication, from a lower layer, identifying an master security key update information.

Referring to FIG. 8, the process 800 may begin in operation 801. In operation 801, UE receives a list of master security configurations in an LTM configuration. Each master security configuration includes a master security configuration ID and associated master security key update information. Then, the process 800 proceeds to operation 803.

In operation 803, UE adds, modifies, or releases one or more master security configurations based on a variable that stores the LTM configuration. Then, the process 800 proceeds to operation 805.

In operation 805, UE receives an indication by a lower layer (L1 or L2) that an LTM cell switch from a source cell to a target cell is triggered by for an MCG. Then, the process 800 proceeds to operation 807.

In operation 807, UE performs the LTM cell switch. A master security configuration ID is indicated from a lower layer. UE performs an AS security key update based a master key update information which is identified by the master security configuration ID indicated by the lower layer.

In some embodiments, for each LTM candidate cell, the network provides master security key update information in the LTM cell switch command MAC CE. In some embodiments, when UE receives an indication by a lower layer that an LTM cell switch procedure is triggered for an MCG, UE performs the following operations:
If the LTM cell switch is triggered by an indication from lower layers, or if (conditional) reconfiguration execution is performed for subsequent LTM:
   UE applies the RRCReconfiguration message in ltm-CandidateConfig within LTM-Candidate IE in VarLTM-Config identified by the LTM candidate configuration identity received from lower layers, and/or
   if the master security key update information (e.g., the field keySetChangeIndicator and/or the field nextHopChainingCount) is received from the lower layer:
      perform AS security key update procedure using the information received from lower layer, and/or
      remove the selected ltm-masterSecurityConfig in VarLTM-Config.

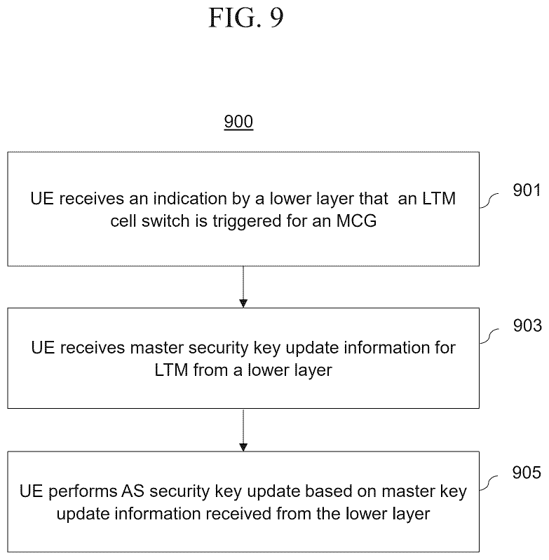

FIG. 9 shows an example process 900 for updating a master security key in accordance with an embodiment. For explanatory and illustration purposes, the example process 900 may be performed by a UE. Although one or more operations are described or shown in particular sequential order, in other embodiments the operations may be rearranged in a different order, which may include performance of multiple operations in at least partially overlapping time periods. In this example, the master security key update in LTM is based on master security key update information received from a lower layer.

Referring to FIG. 9, the process 900 may begin in operation 901. In operation 901, UE receives an indication by a lower layer (L1 or L2) that an LTM cell switch is triggered for an MCG. Then, the process 900 proceeds to operation 903.

In operation 903, UE receives master security key update information for the LTM from a lower layer. Then, the process 900 proceeds to operation 905.

In operation 905, UE performs the LTM cell switch. UE performs an AS security key update based on master key update information received from the lower layer.

In some embodiments, a security configuration including a list of master security key update information may be configured for LTM. UE performs a master security key update based on a master security key update request included in an LTM cell switch command MAC CE.

In some embodiments, UE receives an MCG LTM configuration which includes a security configuration. In an implementation, a security configuration (ltm-SecurityConfig) is included in the LTM configuration for the MCG (LTM-Config). The ltm-SecurityConfig includes a list of master security configurations to add or modify (ltm-masterSecurityConfigToAddModList), and a list of master security configurations to release (ltm-masterSecurityConfigToReleaseList) as shown below:
The ltm-masterSecurityConfigToAddModList can include
   a list of the LTM master security key update configuration (ltm-masterSecurityConfig), and each entry includes
      the ID of the LTM master security information (ltm-masterSecurityConfigID), and/or
      a field keySetChangeIndicator as aforementioned, and/or
      a field nextHopChainingCount as aforementioned, and/or
      a field nas-Container as aforementioned.
The ltm-masterSecurityCellSetToReleaseList can include the IDs of master security key update configuration, (ltm-masterSecurityConfigID).

In some embodiments, the security configuration (ltm-SecurityConfig) is included in the LTM configuration. UE maintains a variable (VarLTM-Config) to store the security configuration for the LTM configuration of MCG and performs the following operations:
if the received LTM-Config includes ltm-masterSecurityConfigToReleaseList:
   if VarLTM-Config includes an ltm-masterSecurityConfig with an ltm-masterSecurityConfigID that is included in ltm-masterSecurityConfigToReleaseList,
      remove the entry ltm-masterSecurityConfig identified by the ltm-masterSecurityConfigID from VarLTM-Config.
if the received LTM-Config includes ltm-masterSecurityConfigToAddModList:
   For an ltm-masterSecurityConfig with an ltm-masterSecurityConfigID in ltm-masterSecurityConfigToAddModList, and if VarLTM-Config includes an ltm-masterSecurityConfig with the same ltm-masterSecurityConfigID,
      replace the entry ltm-masterSecurityConfig in VarLTM-Config with the received ltm-masterSecurityConfig identified by the ltm-masterSecurityConfigID;
   else,
      add the received ltm-masterSecurityConfig with the ltm-masterSecurityConfigID to VarLTM-Config.

In some embodiments, an LTM cell switch command MAC CE may include a field to indicate a master security key update request. UE may select the ltm-masterSecurityConfig identified by the ltm-masterSecurityConfigID that has the lowest value in the UE variable for master security key update. For LTM cell switch execution, upon receiving an indication by a lower layer that an LTM cell switch is triggered for the MCG, the UE performs the following operations:
If the LTM cell switch is triggered by an indication from lower layers, or if (conditional) reconfiguration execution is performed for subsequent LTM:
   UE applies the RRCReconfiguration message in ltm-CandidateConfig within LTM-Candidate IE in VarLTM-Config identified by the LTM candidate configuration identity received from lower layers, and/or
   if the master security key update request is received from the lower layer:
      select the ltm-masterSecurityConfig identified by the lowest value of ltm-masterSecurityConfigID in the VarLTM-Config,
      perform AS security key update procedure using the information in ltm-masterSecurityConfig, and/or
      remove the selected ltm-masterSecurityConfig in VarLTM-Config.

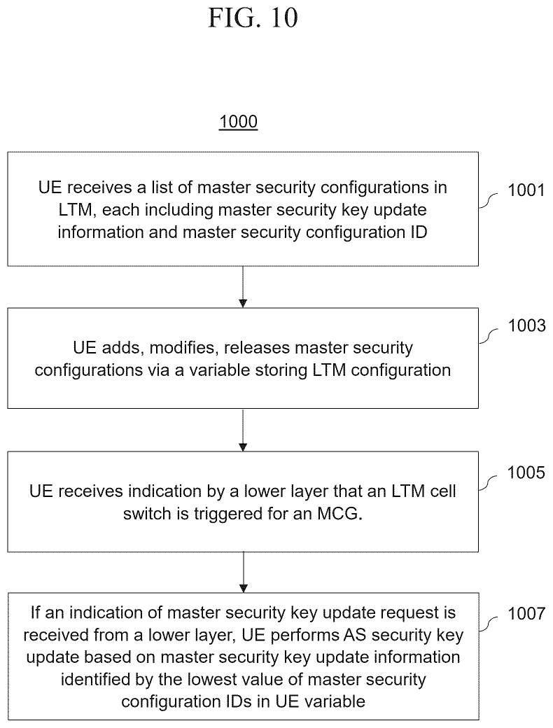

FIG. 10 shows an example process 1000 for updating a master security key in accordance with an embodiment. For explanatory and illustration purposes, the example process 1000 may be performed by a UE. Although one or more operations are described or shown in particular sequential order, in other embodiments the operations may be rearranged in a different order, which may include performance of multiple operations in at least partially overlapping time periods. In this example, the master security key update in LTM is based on pre-configured master security key update information and an indicated master security key update request.

Referring to FIG. 10, the process 1000 may begin in operation 1001. In operation 1001, UE receives a list of master security configurations in an LTM configuration. Each master security configuration includes a master security key update information and a master security configuration ID. Then, the process 1000 proceeds to operation 1003.

In operation 1003, UE adds, modifies, or releases one or more master security configurations using a variable storing the LTM configuration. Then, the process 1000 proceeds to operation 1005.

In operation 1005, UE receives an indication by a lower layer that an LTM cell switch is triggered for an MCG. Then, the process 1000 proceeds to operation 1007.

In operation 1007, UE performs the LTM cell switch. If an indication requesting a master security key update is received from a lower layer, UE performs an AS security key update based on the master security key update information associated with the lowest value among the master security configuration IDs stored in the variable.

In some embodiments, a security configuration including a list of master security configurations may be configured for LTM. The network notifies UE of a master security configuration ID to perform a master security key update. UE may receive the MCG LTM configuration which includes a security configuration. In an implementation, a security configuration (ltm-SecurityConfig) is included in the LTM configuration for the MCG (LTM-Config). The ltm-SecurityConfig includes a list of master security configurations to add or modify (ltm-masterSecurityCellSetToAddModList), and a list of master security configurations to release (ltm-masterSecurityCellSetToReleaseList) as shown below:
The ltm-masterSecurityCellSetToAddModList can include a list of master security configurations (namely, ltm-masterSecurityConfig), where each ltm-masterSecurityConfig can include
   a list of the LTM master security key update information (namely, ltm-masterKeyUpdateList), and each entry (namely, ltm-masterKeyUpdate) in the list can include
      the ID of the LTM master security key update information (namely, ltm-masterKeyID), and/or
      a field keySetChangeIndicator as aforementioned, and/or
      a field nextHopChainingCount as aforementioned, and/or
      a field nas-Container as aforementioned.
   the master security configuration ID (e.g., ltm-masterSecurityConfigID).
The ltm-masterSecurityCellSetToReleaseList can include a list of master security configuration IDs, (e.g., ltm-masterSecurityConfigID).

In some embodiments, UE maintains a variable (VarLTM-Config) to store the security configuration for the LTM configuration of MCG and performs the following operations:
if the received LTM-Config includes ltm-masterSecurityCellSetToReleaseList:
   if VarLTM-Config includes an ltm-masterSecurityConfig associated with an ltm-masterSecurityConfigID that is included in ltm-masterSecurityCellSetToReleaseList,
      remove the entry ltm-masterSecurityConfig associated with the ltm-masterSecurityConfigID from VarLTM-Config.
if the received LTM-Config includes ltm-masterSecurityCellSetToAddModList:
   For an ltm-masterSecurityConfig with an ltm-masterSecurityConfigID in ltm-masterSecurityCellSetToAddModList, and if VarLTM-Config includes an ltm-masterSecurityConfig with the same ltm-masterSecurityConfigID,
   replace the entry ltm-masterSecurityConfig in VarLTM-Config with the received ltm-masterSecurityConfig identified by the ltm-masterSecurityConfigID;
else,
   add the received ltm-masterSecurityConfig with the ltm-masterSecurityConfigID to VarLTM-Config.

In some embodiments, the LTM cell switch command MAC CE may include a field to indicate the Master Key ID to identify the master security key update information configured in higher layer. UE applies the ltm-masterSecurityConfig identified by the ltm-masterSecurityConfigID that has the same value of Master Key ID indicated in the MAC CE for master security key update. For LTM cell switch execution, upon the indication by lower layers that an LTM cell switch procedure is triggered for the MCG, the UE performs the following operations:
If the LTM cell switch is triggered by an indication from lower layers, or if (conditional) reconfiguration execution is performed for subsequent LTM:
   UE applies the RRCReconfiguration message in ltm-CandidateConfig within LTM-Candidate IE in VarLTM-Config identified by the LTM candidate configuration identity received from lower layers, and/or
   if the value of Master Key ID is received from the lower layer:
      in the ltm-masterSecurityConfig in the VarLTM-Config identified by an ltm-masterSecurityConfigID matching the value of Master Key ID indicated by lower layers, select the first entry ltm-masterKeyUpdate in the ltm-masterKeyUpdateList,
      perform AS security key update procedure using the information in ltm-masterKeyUpdate, and/or
      remove the selected ltm-masterKeyUpdate in the ltm-masterKeyUpdateList included in ltm-masterSecurityConfig in VarLTM-Config.

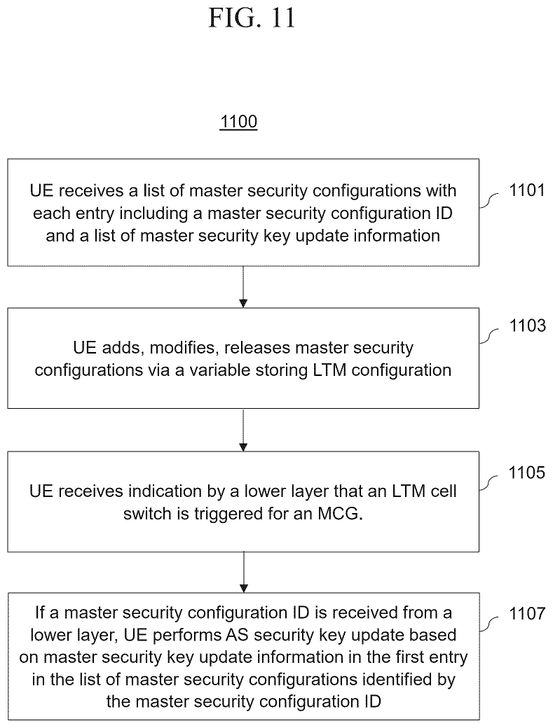

FIG. 11 shows an example process 1100 for updating a master security key update in accordance with an embodiment. For explanatory and illustration purposes, the example process 1100 may be performed by a UE. Although one or more operations are described or shown in particular sequential order, in other embodiments the operations may be rearranged in a different order, which may include performance of multiple operations in at least partially overlapping time periods. In this example, the master security key update in LTM is based on pre-configured cell-group based master security key update information list and an indicated master security configuration ID.

Referring to FIG. 11, the process 1100 may begin in operation 1101. In operation 1101, UE receives a list of master security configurations in an LTM configuration. The list of master security configurations includes one or more entries. Each entry includes a master security configuration ID and a list of master security key update information. Then, the process 1100 proceeds to operation 1103.

In operation 1103, UE adds, modifies, or releases one or more master security configurations using a variable storing the LTM configuration. Then, the process 1100 proceeds to operation 1105.

In operation 1105, UE receives an indication by a lower layer that an LTM cell switch is triggered for an MCG. Then, the process 1100 proceeds to operation 1107.

In operation 1107, UE performs the LTM cell switch. If a master security configuration ID is received from a lower layer, UE performs an AS security key update based on the master security key update information in the first entry of the list of master security configurations that may be identified by the master security configuration ID.

In some embodiments, the AS security key update may operate as follows:
1> If the master security key update information (e.g., the field keySetChangeIndicator and/or the field nextHopChainingCount) is selected from the pre-configured LTM security configuration and/or provided by lower layer indication for LTM execution:
   2> if the keySetChangeIndicator is set to 1:
      3> derive or update the K_{gNB} key based on the K_{AMF} key;
   2> else:
   3> derive or update the K_{gNB} key based on the current K_{gNB} key or the NH, using the nextHopChainingCount value indicated by the lower layer;
2> store the nextHopChainingCount value;
2> derive the keys associated with the K_{gNB} key as follows:
   3> if the securityAlgorithmConfig is included in SecurityConfig:
      4> derive the K_{RRCenc} and K_{UPenc} keys associated with the cipheringAlgorithm indicated in the securityAlgorithmConfig;
      4> derive the K_{RRCint} and K_{UPint} keys associated with the integrityProtAlgorithm indicated in the securityAlgorithmConfig;
3> else:
   4> derive the K_{RRCene} and K_{UPenc} keys associated with the current cipheringAlgorithm;
   4> derive the K_{RRCint} and K_{UPint} keys associated with the current integrityProtAlgorithm.

In some embodiments, UE may report the master security key update information selected from the pre-configured security configuration. In an implementation, in the RRCReconfigurationComplete message for LTM, the UE may set the content of the RRCReconfigurationComplete message as follows:
1> if the RRCReconfiguration includes the reconfigurationWithSync in spCellConfig of an MCG:
   2> if a new K_gNB key value has been selected and/or derived by performing AS security key update procedure due to the (conditional) reconfiguration execution for subsequent LTM:
      3> include selectedKgNB and set its value to the selected KgNB key value;
   2> if the RRCReconfiguration message is applied due to (conditional) reconfiguration execution for subsequent LTM:
      3> include in the selectedPCellForCLTM and set it to the information (PCI and/or a logical ID) of the selected PCell.

In some embodiments, UE receives master security key update information through a MAC CE (e.g., LTM cell switch command MAC CE). Then, UE sends the received information to a higher layer for an AS security key update.

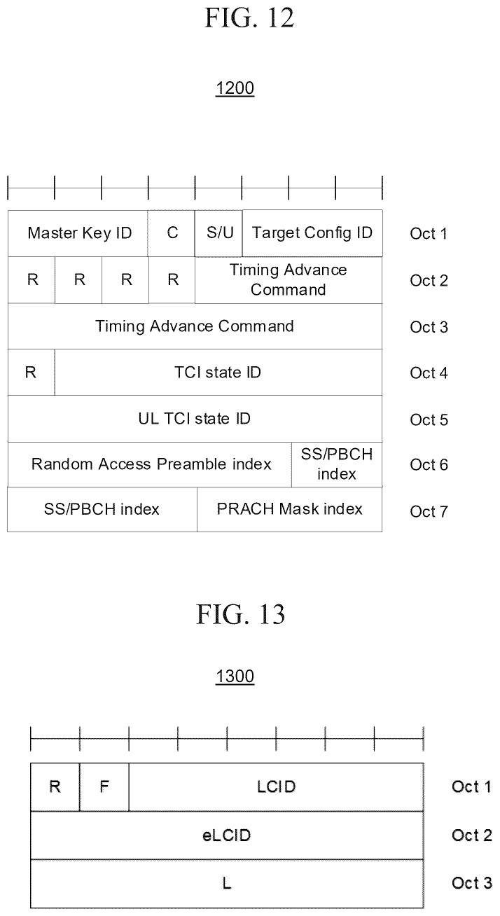

FIG. 12 shows an example of an LTM cell switch command MAC CE 1200 in accordance with an embodiment.

Referring to FIG. 12, the LTM cell switch command MAC CE 1200 includes a Master Key ID field that indicates the master security key update information that is pre-configured in a higher layer to be applied for master security key update for LTM. An existing LTM cell switch command MAC CE or an enhanced LTM cell switch command MAC CE can be used. The MAC CE 1200 may be identified by an MAC subheader with the eLCID as specified in Table 1. An example of the MAC subheader for the MAC CE is shown in FIG. 13.

FIG. 13 shows an example MAC subheader 1300 for the LTM cell switch MAC CE in accordance with an embodiment.

Referring to FIG. 13, the MAC subheader 1300 includes a Reserved (R) bit, a Format (F) bit, a Logical Channel ID (LCID) field, an enhanced LCID (eLCID) field, and L field with 8 bits. In an embodiment, the eLCID for an enhanced LTM cell switch command MAC CE is specified with a reserved codepoint of 224 and a reserved index of 288 in Table 1. In addition, the eLCID for an LTM cell switch command MAC CE is specified with a reserved codepoint of 225 and a reserved index of 289 in Table 1 that shows an example value of one-octet eLCID for downlink shared channel (DL-SCH).

TABLE 1

| Codepoint | Index | LCID values |
|---|---|---|
| 0 to 223 | 64 to 287 | Reserved |
| 224 | 288 | Enhanced LTM Cell Switch Command |
| 225 | 289 | LTM Cell Switch Command |

Referring back to FIG. 12, the Master Key ID field is set to 0 to indicate that master security key update is not triggered. When the field is set to a value larger than 0, it indicates a Master Key ID. The length of this field in this example may be 3 bits. Other fields in FIG. 12 that are not described in this disclosure are similar to or the same as the fields in the existing MAC CE.

In some embodiments, UE may perform the following operations in the MAC layer when receiving an LTM cell switch command MAC CE. The MAC entity may:
1> if the MAC entity receives an LTM Cell Switch Command MAC CE on a Serving Cell:
   2> indicate to upper layers that the LTM cell switch procedure is triggered and the Target Configuration ID included in the MAC CE;
   2> if Master Key ID is included in the MAC CE or if Master Key ID with a value larger than 0 is included in the MAC CE:
      3> indicate to upper layer the Master key ID.

In some embodiments, an LTM cell switch command MAC CE may include a keySetChangeIndicator field and/or nextHopChainingCount field, that indicates master security key update information for LTM. The existing LTM cell switch command MAC CE or an enhanced LTM cell switch command MAC CE may be used.

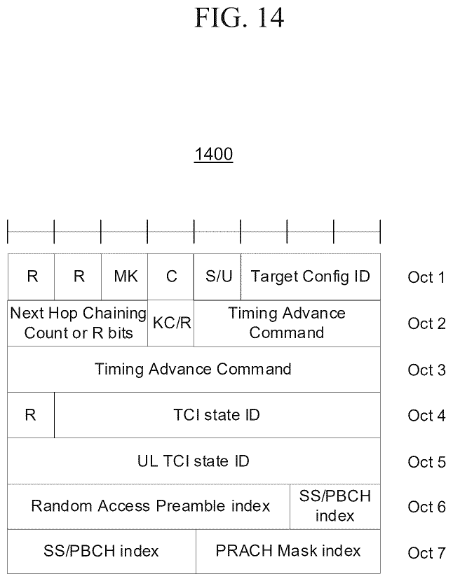

FIG. 14 shows an example of an LTM cell switch command MAC CE 1400 in accordance with an embodiment.

Referring to FIG. 14, the LTM cell switch command MAC CE 1400 includes a master key (MK) field, a keySetChangeIndicator (KC) field, and a Next Hop Chaining Count field.

The MK field indicates whether the master security key update information is present or not in the MAC CE 1400. This field is set to 1 to indicate the KC field or/and the Next Hop Chaining Count field is present. This field is set to 0 to indicate the KC field or/and the Next Hop Chaining Count field is absent, and R bits are present instead. The length of this field may be one (1) bit.

The KC field is sent to 1 to indicate that a K_gNB key is derived from a K_AMF key taken into use through the latest successful NAS SMC procedure, or N2 handover procedure with K_AMF change for K_gNB re-keying. The KC field is set to 0 to indicate that the new K_gNB key is obtained from the current K_gNB key or from the next hop key. The length of this field may be one (1) bit.

The Next Hop Chaining Coun field indicates the integer value of Next Hop Chaining Count to be used to derive the master key K_gNB. The length of this field may be three (3) bits. Other fields in FIG. 14 that are not described in this disclosure are similar to or the same as the fields in the existing MAC CE.

In some embodiments, UE performs the following operations in the MAC layer when receiving an LTM cell switch command MAC CE. The MAC entity may:
1> if the MAC entity receives an LTM Cell Switch Command MAC CE on a Serving Cell:
   2> indicate to upper layers that the LTM cell switch procedure is triggered and the Target Configuration ID included in the MAC CE;
   2> if master security key update information (e.g., the field keySetChangeIndicator and/or the field nextHopChainingCount) is included in the MAC CE
      3> indicate to upper layer the master security key update information (e.g., the field keySetChangeIndicator and/or the field nextHopChainingCount).

In some embodiments, UE may receive a secondary security key update information in a MAC CE such as an LTM cell switch command MAC CE. Then UE may send the secondary security key update information to a higher layer for an AS security key update. The MAC CE may include a field to indicate a secondary key ID. The secondary key ID identifies the secondary security key update information pre-configured in a higher layer to be applied for the secondary security key update for LTM. The existing LTM cell switch command MAC CE or an enhanced LTM cell switch command MAC CE can be used. The MAC CE can be identified by a MAC subheader with the eLCID as specified in Table 1.

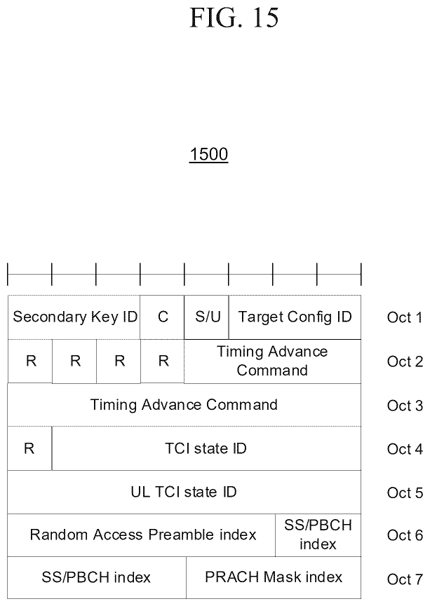

FIG. 15 shows an example of an LTM cell switch command MAC CE 1500 in accordance with an embodiment.

Referring to FIG. 15, the LTM cell switch command MAC CE 1500 includes a Secondary Key ID field. This field indicates a Secondary Key ID. This field may be set to 0 to indicate that the secondary security key update is not triggered. This field may be set to a value larger than 0 to indicate the Secondary Key ID. The length of this field may be three (3) bits. Other fields in FIG. 15 that are not described in this disclosure are similar to or the same as the fields in the existing MAC CE.

In some embodiments, UE performs the following operations in the MAC layer when receiving an LTM cell switch command MAC CE. The MAC entity may:
1> if the MAC entity receives an LTM Cell Switch Command MAC CE on a Serving Cell:
   2> indicate to upper layers that the LTM cell switch procedure is triggered and the Target Configuration ID included in the MAC CE;
   2> if Secondary Key ID is included in the MAC CE or if Secondary Key ID with a value larger than 0 is included in the MAC CE:
      3> indicate to upper layer the Secondary key ID.

In some embodiments, an LTM cell switch command MAC CE may include a secondary key counter (SK-counter) field that indicates secondary security key update information for LTM. The existing LTM cell switch command MAC CE or an enhanced LTM cell switch command MAC CE can be used. The MAC CE can be identified by a MAC subheader with the eLCID as specified in Table 1.

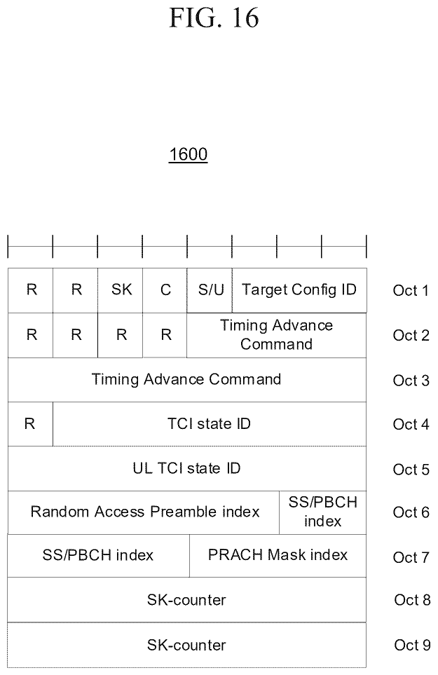

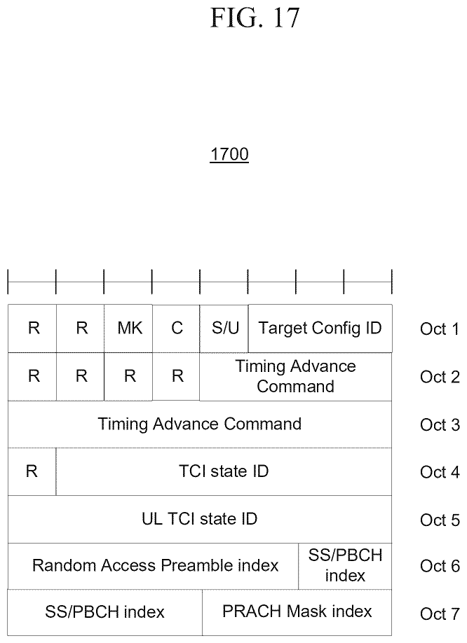

FIG. 16 shows an example of an LTM cell switch command MAC CE 1600 in accordance with an embodiment.

Referring to FIG. 16, the LTM cell switch command MAC CE 1600 includes a SK field and a SK-Counter field.

The SK field indicates whether the secondary security key update information is present or not in the MAC CE 1600. This field may be set to 1 to indicate the SK-Counter field is present. Conversely, this field may be set to 0 to indicate the SK-Counter field is absent and R bits are present instead. The length of this field may be one (1) bit.

The SK counter field indicates a value of SK-counter that is used to derive the secondary key S-KgNB. The length of this field may be 16 bits. The field set to 0, 1, . . . , 65535 indicates the integer value of 0, 1, . . . , 65535, respectively.

In some embodiments, UE performs the following operations in the MAC layer when receiving an LTM cell switch command MAC CE. The MAC entity may:
1> if the MAC entity receives an LTM Cell Switch Command MAC CE on a Serving Cell:
   2> indicate to upper layers that the LTM cell switch procedure is triggered and the Target Configuration ID included in the MAC CE;
   2> if secondary security key update information (e.g., the field SK-Counter) is included in the MAC CE
      3> indicate to upper layer the secondary security key update information (e.g., the field SK-counter).

FIG. 17 shows an example of an LTM cell switch command MAC CE 1700 in accordance with an embodiment.

Referring to FIG. 17, the LTM cell switch command MAC CE 1700 includes a master key (MK) field.

When the MK field is set to 1, it indicates that the master security key update is requested. When this field is set to 0, it indicates that the master security key is not requested. The length of this field may be one (1) bit. Other fields in FIG. 17 that are not described in this disclosure are similar to or the same as the fields in the existing MAC CE.

In some embodiments, UE performs the following procedure in MAC layer when receiving an LTM cell switch command MAC CE. The MAC entity may:
1> if the MAC entity receives an LTM Cell Switch Command MAC CE on a Serving Cell:
   2> indicate to upper layers that the LTM cell switch procedure is triggered and the Target Configuration ID included in the MAC CE;
   2> if master security key update request is indicated in the MAC CE
      3> indicate to upper layer the master security key update request.

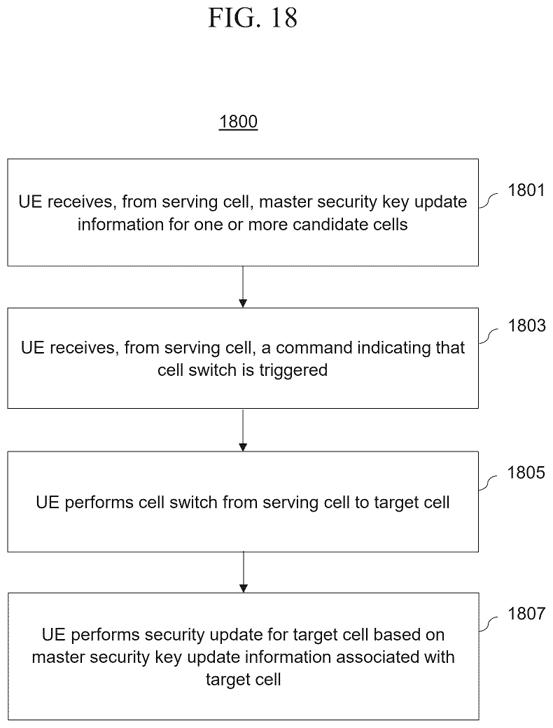

FIG. 18 shows an example process 1800 for updating a master security key in accordance with an embodiment. For explanatory and illustration purposes, the example process 1800 may be performed by a UE. Although one or more operations are described or shown in particular sequential order, in other embodiments the operations may be rearranged in a different order, which may include performance of multiple operations in at least partially overlapping time periods.

Referring to FIG. 18, the process 1800 may begin in operation 1801. In operation 1801, UE receives, from a serving cell, master security key update information for one or more candidate cells. In some embodiments, UE receives, from the serving cell, a master security key update identifier for each candidate cell.

In operation 1803, UE receives, from the serving cell, a command indicating that a cell switch from the serving cell to a target cell among the one or more candidate cells is triggered. In some embodiments, the command includes a master security update information identifier associated with the target cell.

In operation 1805, UE performs the cell switch from the serving cell to the target cell.

In operation 1807, UE performs a security update for the target cell based on the master security key update information associated with the target cell. In some embodiments, UE maintains a variable to store a master security key update identifier for the serving cell, and performs the security update based on a determination that a master security key update identifier of the target cell is different from the master security key update identifier for the serving cell stored in the variable. In some embodiments, UE replaces the master security key update identifier stored in the variable with the master security key update identifier of the target cell.

In some embodiments, UE receives a list of master security update information including one or more entries for a respective candidate cell. Each entry comprises master security key update information. UE performs the security update based on master key security key update information in a predetermined entry or an entry indicated in the list of master security update information associated with the target cell. UE removes the predetermined entry, or the entry indicated in the list of master security update information associated with the target cell.

In some embodiments, UE receives the master security update information associated with the target cell in the cell switch command. UE performs the security update for the target cell based on the master security update information.

In some embodiments, the master security key update information includes a first field indicating whether the UE is required to derive a new master security key and a second field including a parameter used to derive the new master security key.

The present disclosure provides various embodiments to perform a master security key update in various scenarios, such as subsequent LTM or conditional LTM, both inter-CU and intra-CU LTM. The present disclosure provides various embodiments to provide the configuration of master security key update for a list of LTM candidate cells and the security key update procedure for an LTM cell switch.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a transceiver configured to:
receive, from a serving cell, master security key update information for one or more candidate cells; and
receive, from the serving cell, a command indicating that a cell switch from the serving cell to a target cell among the one or more candidate cells is triggered; and
a processor operably coupled to the transceiver, the processor configured to:
perform the cell switch from the serving cell to the target cell; and
perform a security update for the target cell based on master security key update information associated with the target cell.

2. The UE of claim 1, wherein:
the transceiver is further configured to:
receive, from the serving cell, a master security key update identifier for each candidate cell; and
the processor is further configured to:
maintain a variable to store a master security key update identifier for the serving cell; and
perform the security update based on a determination that a master security key update identifier of the target cell is different from the master security key update identifier for the serving cell stored in the variable.

3. The UE of claim 2, wherein the processor is further configured to replace the master security key update identifier stored in the variable with the master security key update identifier of the target cell.

4. The UE of claim 1, wherein the transceiver is further configured to receive a list of master security update information including one or more entries for a respective candidate cell, each entry comprising master security key update information.

5. The UE of claim 4, wherein the processor is configured to perform the security update based on master security key update information in a predetermined entry or an entry indicated in the list of master security update information associated with the target cell.

6. The UE of claim 5, wherein the processor is further configured to remove the predetermined entry or the entry indicated in the list of master security update information associated with the target cell.

7. The UE of claim 1, wherein:
the command includes a master security update information identifier associated with the target cell; and
the security update is performed based on master security update information identified by the master security update information identifier.

8. The UE of claim 1, wherein:
the master security update information associated with the target cell is included in the command; and
the security update for the target cell is performed based on the master security update information.

9. The UE of claim 1, wherein the master security key update information includes:
a first field indicating whether the UE is required to derive a new master security key; and
a second field including a parameter used to derive the new master security key.

10. A method performed by a user equipment (UE) in a wireless network, the method comprising:
receiving, from a serving cell, master security key update information for one or more candidate cells;
receiving, from the serving cell, a command indicating that a cell switch from the serving cell to a target cell among the one or more candidate cells is triggered;
performing the cell switch from the serving cell to the target cell; and
performing a security update for the target cell based on master security key update information associated with the target cell.

11. The method of claim 10, further comprising:
receiving, from the serving cell, a master security key update identifier for each candidate cell;
maintaining a variable to store a master security key update identifier for the serving cell; and
performing the security update based on a determination that a master security key update identifier of the target cell is different from the master security key update identifier for the serving cell stored in the variable.

12. The method of claim 11, further comprising replacing the master security key update identifier stored in the variable with the master security key update identifier of the target cell.

13. The method of claim 10, further comprising receiving a list of master security update information including one or more entries for a respective candidate cell, each entry comprising master security key update information.

14. The method of claim 13, wherein the security update is performed based on master security key update information in a predetermined entry or an entry indicated in the list of master security update information associated with the target cell.

15. The method of claim 14, further comprising removing the predetermined entry or the entry indicated in the list of master security update information associated with the target cell.

16. The method of claim 10, wherein:
the command includes a master security update information identifier associated with the target cell; and
the security update is performed based on master security update information identified by the master security update information identifier.

17. The method of claim 10, wherein:
the master security update information associated with the target cell is included in the command; and
the security update for the target cell is performed based on the master security update information.

18. The method of claim 10, wherein the master security key update information includes:
a first field indicating whether the UE is required to derive a new master security key; and
a second field including a parameter used to derive the new master security key.

19. A base station (BS) for facilitating communication in a wireless network, the BS comprising:
a transceiver configured to:
transmit, to a user equipment (UE), master security key update information for one or more candidate cells; and
transmit, to the UE, a command indicating that a cell switch from a serving cell of the BS to a target cell among the one or more candidate cells is triggered,
wherein master security key update information associated with the target cell is used for a security update for the target cell.

20. The BS of claim 19, wherein the transceiver is further configured to:
transmit, to the UE, a master security key update identifier for each candidate cell.
